(19) United States
(12) Patent Application Publication
(10) Pub. No.: US 2014/0183415 A1
(43) Pub. Date: Jul. 3, 2014

(54) Graphene-Based Composite and Method of Preparing the Same

(71) Applicant: Cheil Industries Inc., Gumi-si (KR)

(72) Inventor: Lee Hwa SONG, Uiwang-si (KR)

(73) Assignee: Cheil Industries Inc., Gumi-si (KR)

(21) Appl. No.: 14/108,716

(22) Filed: Dec. 17, 2013

(30) Foreign Application Priority Data
Dec. 31, 2012 (KR) 10-2012-0158157
Mar. 7, 2013 (KR) 10-2013-0024716
Apr. 1, 2013 (KR) 10-2013-0035042

(51) Int. Cl. H01G 11/32; B01J 21/18; H01M 4/36

(52) U.S. Cl. CPC H01G 11/32; H01M 4/362; B01J 21/18
USPC 252/502; 429/231.8; 502/439; 361/502

(57) ABSTRACT

A graphene-based composite includes graphene and a structure former contacting the graphite, wherein the structure former is a metal oxide or a carbon compound and includes pores therein, and the graphene-based composite has a porous particle structure. The graphene-based composite can have a large specific surface area and excellent charge storage capacity.

### CROSS-REFERENCE TO RELATED APPLICATION

This application claims priority under 35 USC Section 119 to and the benefit of Korean Patent Application 10-2012-0158157, filed Dec. 31, 2012; Korean Patent Application No. 10-2013-0024716, filed Mar. 7, 2013; and Korean Patent Application No. 10-2013-0035042, filed Apr. 1, 2013, the entire disclosure of each of which is incorporated herein by reference.

### FIELD OF THE INVENTION

The present invention relates to a graphene-based composite and a method of preparing the same. More particularly, the present invention relates to a graphene-based composite, which has a novel porous particle structure, and a method of preparing the same.

### BACKGROUND OF THE INVENTION

When carbon layers are bonded by Van der Waals attraction, if carbon layers are stacked one above another to form a three-dimensional structure, graphite is formed. If the carbon layers form a tubular shape, a carbon nanotube (CNT) is formed, and if the carbon layers form a globular shape, fullerene is formed. In addition, if carbon atoms form a two-dimensional honeycomb material having a thickness of one atomic layer, graphene is formed.

Graphene has a surface area of about 2,000 m²/g and is an extremely excellent conductor having an electron mobility (about 200,000 cm²/Vs) 100 times higher than that of silicon. Further, graphene has extremely low electric resistance, ⅔ that of copper, a breaking strength of about 42 N/m, and Young's modulus similar to diamond so as to have excellent mechanical strength. Thus, various attempts have been made to apply graphene exhibiting such excellent properties to electrodes, composites, and the like.

A typical method for synthesizing graphene includes chemical vapor deposition (CVD) which is a bottom-up method, and chemical synthesis which is a top-down method. The two methods are applied to different fields based on properties of produced graphene. When graphine is synthesized by CVD, a sheet of high-quality graphene can be synthesized and applied to transparent electrodes, flexible displays, and the like.

Chemical synthesis is a process of preparing graphene through exfoliation of natural graphite, and includes a modified Hummer's method as a representative method. According to this method, after natural graphite is oxidized into graphene oxide using an acid, the graphene oxide is separated into individual layers through ultrasound dispersion in water, followed by thermal reduction or reduction using a reducing agent, thereby preparing graphene. As such, graphene prepared by reducing graphene oxide may also be referred to as reduced graphene oxide.

However, the graphene prepared by chemical synthesis has chemical defects due to creation of carboxyl groups, epoxy groups and the like, and has a problem in that the graphene is likely to fracture into small pieces when the graphene is stacked or subjected to ultrasound dispersion. Thus, graphene prepared by chemical synthesis exhibits significantly inferior properties to original graphene in terms of conductivity, specific surface area, and the like.

To solve such problems of graphene prepared by chemical synthesis, various methods such as insertion of metal particles between graphene, dispersion of graphene along with carbon nanotubes (CNTs) to improve a problem of contact due to small pieces, and the like have been developed. In most methods developed in the art, a composite combined with graphene is prepared through simple mixing, or a composite of graphene and metal particles is prepared using an existing sol-gel method. However, since such methods have a problem in that graphene is covered with the metal particles, there is a drawback in that it is difficult to use properties of graphene.

Therefore, there is a need for a graphene-based composite capable of maximizing effects of material transfer, heat transfer and the like, which are required when a graphene-based composite is applied to electrodes, catalyst carriers and the like, while maintaining inherent properties of graphene such as conductivity and the like.

### SUMMARY OF THE INVENTION

The present invention provides a novel graphene-based composite, which can secure both an ion transfer path and an electrical conduction path, have a large specific surface area and a capacitance (charge storage capacity) of about 150 F/g or more, and prevent a problem of stacking graphene, and a method of preparing the same.

The graphene-based composite includes: graphene; and a structure former contacting the graphene, wherein the structure former is a metal oxide or a carbon compound and includes pores therein, and the graphene-based composite has a porous particle structure.

In one embodiment, the graphene may include a plurality of graphene layers separated a predetermined distance from each other; the structure former may be intercalated between the graphene layers; and the pores may form channels.

In another embodiment, the graphene-based composite may have a non-repetitive and irregular three-dimensional structure.

The present invention also relates to a method of preparing a graphene-based composite.

In one embodiment, the method includes: preparing a precursor solution by placing and dispersing a graphene oxide and a pore agent in a solvent, followed by mixing the precursor solution with a metal oxide precursor; and performing spray and heat treatment of the precursor solution to form a graphene-based composite.

The method may further include: preparing a mold-precursor mixture solution by mixing a carbon precursor and a solvent with a mold using the graphene-based composite as the mold; heating the mold-precursor mixture solution and carbonizing the carbon precursor filling pores of the mold; and removing a metal oxide from the mold through base or acid treatment thereof.

In another embodiment, the method includes: preparing a graphene-carbon-metal oxide composite by mixing graphene, a carbon precursor, a metal oxide precursor, a pore agent and a solvent, followed by heat treatment; and removing a metal oxide from the graphene-carbon-metal oxide composite.

The present invention also relates to a catalyst carrier and an electrode active material, which include at least one of the graphene-based composites.

### BRIEF DESCRIPTION OF THE DRAWINGS

The above and other aspects, features and advantages of the invention will become apparent from the detailed description of the following embodiments given in conjunction with the accompanying drawings, in which:

FIG. 1 is a scanning electron microscope (SEM) image of a graphene-based composite prepared in Example 1;

FIG. 2 is a transmission electron microscope (TEM) image of the graphene-based composite prepared in Example 1;

FIG. 3 is a scanning electron microscope (SEM) image of a porous graphene-based composite prepared in Example 2;

FIG. 4 is a transmission electron microscope (TEM) image of the graphene-based composite prepared in Example 2;

FIG. 5 is a scanning electron microscope (SEM) image of a graphene-based composite prepared in Comparative Example 1;

FIG. 6 is a diagram showing a process of preparing a graphene-based composite according to one embodiment of the present invention;

FIG. 7 shows graphs depicting adsorption and desorption of nitrogen of graphene-based composite particles and metal oxide particles prepared in Examples 1 and 2 and Comparative Example 1;

FIG. 8 is a scanning electron microscope (SEM) image of a graphene-based composite prepared in Example 3;

FIG. 9 is a transmission electron microscope (TEM) image of the graphene-based composite prepared in Example 3;

FIG. 10 is a scanning electron microscope (SEM) image of a graphene-based composite prepared in Example 4;

FIG. 11 is a transmission electron microscope (TEM) image of the graphene-based composite prepared in Example 4;

FIG. 12 is a scanning electron microscope (SEM) image of a graphene-based composite prepared in Comparative Example 2;

FIG. 13 is a scanning electron microscope (SEM) image of a graphene-based composite prepared in Example 5;

FIG. 14 is a graph depicting pore size distribution of the graphene-based composite prepared in Example 5;

FIG. 15 is a scanning electron microscope (SEM) image of a plate-like graphene-based composite prepared in Example 3; and

FIG. 16 shows graphs depicting capacitance of the graphene-based composite and graphene prepared in Example 5 and Comparative Example 3, respectively.

### DETAILED DESCRIPTION OF THE INVENTION

The present invention now will be described more fully hereinafter in the following detailed description of the invention and drawings, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

According to the invention, a graphene-based composite includes graphene, and a structure former contacting the graphene. Here, the structure former is a metal oxide or carbon compound, and includes pores therein. The graphene-based composite has a porous particle structure.

As used herein, the “porous particle” has a spherical shape or a non-repetitive and irregular three-dimensional structure, and excludes flat particles. In addition, the term “irregular” means that a three-dimensional structure of a graphene-based composite does not have a constant and regular shape such as a sphere, a cone and the like, and the term “non-repetitive” means that the graphene-based composite includes a repetitive (three-dimensional) structure or shape in an amount of less than about 10%.

In exemplary embodiments, the pores may have a spherical, irregular, or channel shape. In addition, the pores may have a diameter from about 1 nm to about 50 nm.

In one embodiment, in the graphene-based composite according to the invention, the graphene may include a plurality of graphene layers separated a predetermined distance from each other; the structure former may be intercalated between the graphene layers; and the pores may form channels.

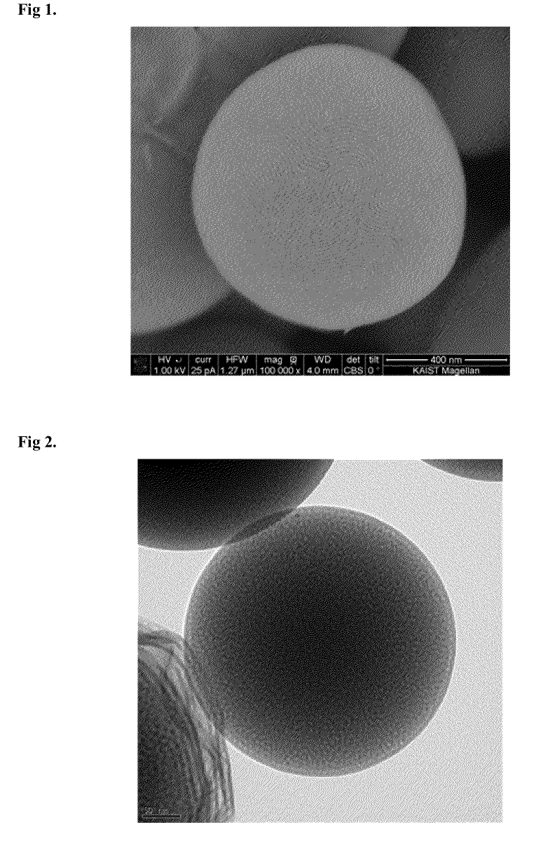

FIG. 1 is a scanning electron microscope (SEM) image of a graphene-based composite prepared in Example 1. As shown in FIG. 1, according to one embodiment, a graphene-based composite (porous graphene-metal oxide composite) is a particle including graphene layers (bright portions of a spherical particle in FIG. 1) and structure formers (metal oxide, dark portions of the spherical particle in FIG. 1), each of which has pores and is intercalated between the graphene layers, and may have a structure in which the graphene layers and the structure formers (metal oxide, metal oxide layer) are alternately stacked on a surface thereof and therein.

FIG. 2 is a transmission electron microscope (TEM) image of the graphene-based composite prepared in Example 1. As shown in FIG. 2, the graphene-based composite according to the invention is a particle including the graphene layers and the structure formers (metal oxide layers), each of which has pores and is intercalated between the graphene layers. Here, the metal oxide layers may have a mesoporous structure, and the pores of the metal oxide layers can maximize effects of material transfer and heat transfer in a gas-liquid or liquid-liquid system due to formation of channels by the pores.

In addition, since the graphene-based composite according to the invention may have a structure in which the graphene layers regularly form a network in the particle and are included in walls of the pores, the graphene-based composite can maintain electrical conductivity even inside the particles.

In the graphene-based composite (porous graphene-metal oxide composite) according to the invention, the graphene layers can have a thickness from about 1 nm to about 10 nm, for example, about 1 nm to about 4 nm, and an interlayer distance (thickness of the metal oxide layer) from about 1 nm to about 100 nm, for example, from about 2 nm to about 90 nm, and as another example from about 6 nm to about 40 nm. Within this range, the graphene-based composite can exhibit inherent properties of graphene.

In addition, the pores of the metal oxide layer can have a diameter from about 1 nm to about 50 nm, for example, from about 4 nm to about 20 nm. Within this range, the graphene-based composite can ensure excellent thermal transfer and electrical conductivity, and can be useful as a catalyst carrier due to a large surface area thereof.

The graphene-based composite (porous graphene-metal oxide composite) according to the invention may be a spherical particle having an average diameter from about 100 nm to about 10,000 nm, as determined dependent upon a diameter of a spray nozzle and spray types during synthesis. Within this range, the graphene-based composite (porous graphene-metal oxide composite) having the aforementioned structure can be obtained.

As used herein, the term “spherical particle” means a “particle having a substantially spherical shape” and may include, for example, ellipses and irregular spheres. The spherical particle may have a ratio of major diameter to minor diameter (major diameter/minor diameter) from about 1.0 to about 1.5.

Examples of the metal oxide may include without limitation silicon oxide (SiO₂), aluminum oxide (Al₂O₃), zirconium oxide (ZrO₂), yttrium oxide (Y₂O₃), titanium oxide (TiO₂), zinc oxide (ZnO), and the like and mixtures thereof. For example, the metal oxide may be silicon oxide.

FIG. 8 is a scanning electron microscope (SEM) image of a graphene-based composite prepared in Example 3. As shown in FIG. 8, a graphene-based composite (porous graphene-carbon composite) according to one embodiment of the invention is a particle including graphene layers and structure formers (carbon compounds) intercalated (stacked) between the graphene layers and having pores to which carbon particles formed by carbonization of a carbon precursor are attached, and may have a structure in which the graphene layers and the structure formers (carbon compound, carbon layer) are alternately stacked on a surface thereof and therein.

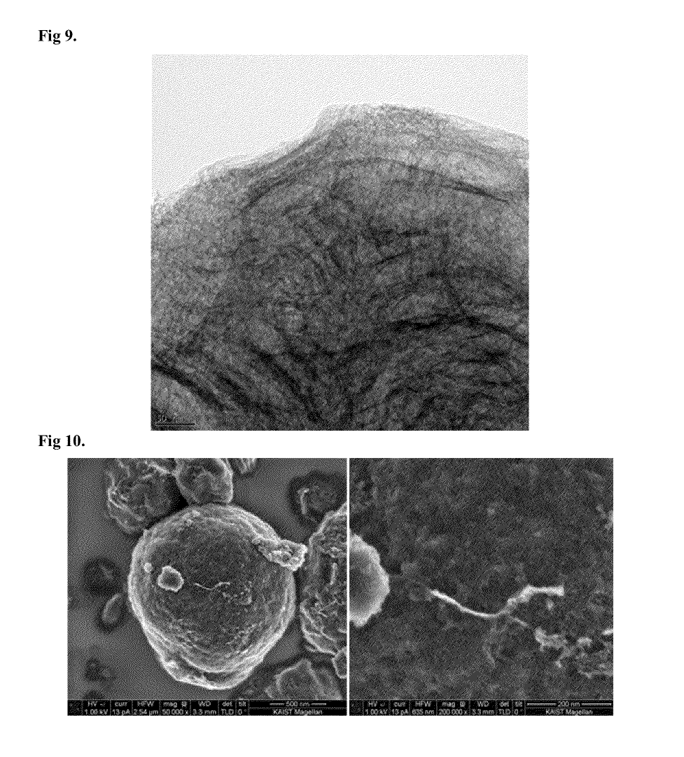

FIG. 9 is a transmission electron microscope (TEM) image of the graphene-based composite prepared in Example 3. As shown in FIG. 9, a graphene-based composite (porous graphene-carbon composite) according to one embodiment of the invention is a spherical particle including graphene layers, carbon layers, pores formed in the carbon layers. Here, the pores of the carbon layers form channels, and the graphene-based composite may have a high specific surface area and exhibit excellent charge storage capacity.

In addition, since the graphene-based composite may have a structure in which the graphene layers regularly form a network in the spherical particle and both the carbon particles of the carbon layers and the pores contact the graphene layers, the graphene-based composite can maintain electrical conductivity even inside the particle.

In the graphene-based composite (porous graphene-carbon composite), the graphene layer may have a thickness from about 1 nm to about 10 nm, for example, from about 1 nm to about 5 nm, and a distance (a thickness of the carbon layer) between the graphene layers from about 1 nm to about 100 nm, for example, from about 1 nm to about 50 nm, and as another example from about 5 nm to about 20 nm. In addition, since a sheet of graphene has a thickness from about 0.3 nm to about 0.4 nm, it can be understood that the total number of graphene layers does not exceed 30.

Further, the pores of the carbon layers can have an average diameter from about 1 nm to about 50 nm, for example, from about 2 nm to about 20 nm. Within this range, the graphene-based composite (porous graphene-carbon composite) according to the invention can have a high specific surface area, and exhibit excellent charge storage capacity and electrical conductivity.

The graphene-based composite (porous graphene-carbon composite) according to the invention is a spherical particle having an average diameter from about 100 nm to about 10,000 nm, for example from about 500 nm to about 5,000 nm.

In the present invention, the carbon layer may be prepared by carbonization of the carbon precursor. Here, the carbon precursor may be any one that can be carbonized to form a network along with neighboring carbon without limitation. Examples of the carbon precursor may include without limitation: carbohydrates such as sucrose, cellulose, and the like; C₄ to C₁₀ alcohols such as butanol, furfuryl alcohol, and the like; C₆ to C₃₀ aromatic compounds such as pyrene, naphthalene, benzene, trimethyl benzene, anthracene, and the like; and mixtures thereof.

The graphene-based composite according to the invention may have a specific surface area from about 300 m²/g to about 1,500 m²/g, for example, from about 700 m²/g to about 1,500 m²/g, and as another example from about 800 m²/g to about 1,500 m²/g, as measured using a nitrogen adsorption-desorption method (BET). Within this range, the graphene-based composite can exhibit excellent charge storage capacity and provide high energy density.

In addition, when the graphene-based composite is produced as an electrode material of an ultrahigh-capacitance capacitor, the electrode material may have a capacitance from about 150 F/g to about 400 F/g, for example, from about 150 F/g to about 300 F/g, and as another example from about 160 F/g to about 295 F/g, as measured by a half cell test (using a 1.0 M sulfuric acid electrolyte) using a cyclic voltammetry apparatus (Solarstron 1480). This capacitance is higher than a maximum capacitance (less than about 150 F/g) of general carbon materials.

In another embodiment, the graphene-based composite has a non-repetitive and irregular three-dimensional structure, and may have a porous particle structure.

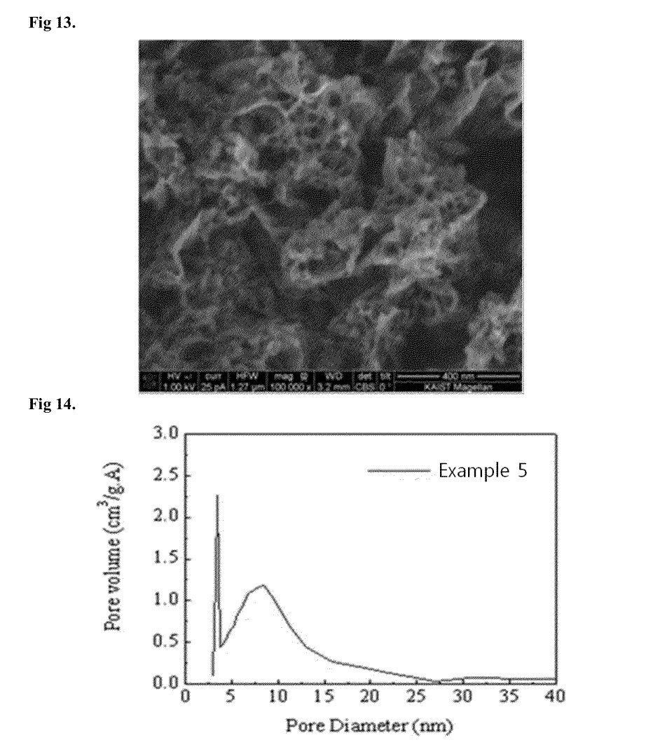

FIG. 13 is a scanning electron microscope (SEM) image of a graphene-based composite prepared in Example 5. As shown in FIG. 13, according to another embodiment of the invention, a graphene-based composite (porous graphene-carbon composite) may be, for example, a porous particle having a non-repetitive and irregular three-dimensional structure, in which a structure former connects at least two three-dimensional graphene structures formed by freely crumpling planar graphene, or the structure former (carbon compound) is coated onto a partial or overall surface of the three-dimensional graphene structure. Here, in the graphene-based composite, the pores may be formed by the carbon compound, and may include a portion of graphene.

In another embodiment of the invention, the graphene-based composite (porous graphene-carbon composite) includes: first pores having an average diameter from about 1 nm to about 5 nm, for example from about 1 nm to about 4 nm; and second pores having an average diameter of greater than about 5 nm and about 50 nm or less, for example from about 5.1 nm to about 30 nm. In addition, the graphene-based composite may have a volume ratio of first pores to second pores (first pores:second pores) from about 1:1 to about 1:50. Within this range, the graphene-based composite can exhibit excellent capacitance. Specifically, the second pores having a relatively large average diameter can reduce internal resistance upon transfer of internal materials and charges/ions, and the first pores having a relatively small average diameter can contribute to enlargement of a surface area the graphene-based composite. Such a large surface area is an important factor to realize high activity of a catalyst or high capacity of an electrode material.

According to another embodiment of the invention, the graphene-based composite (porous graphene-carbon composite) may have any size determined by a size of graphene used as a raw material without limitation.

The graphene-based composite may have a surface area from about 300 m²/g to about 1,500 m²/g, as measured by the Brunauer-Emmett-Teller (BET) method using adsorption and desorption of nitrogen, without being limited thereto.

In addition, the graphene-based composite may have a capacitance from about 150 F/g to about 400 F/g, for example, from about 170 F/g to about 390 F/g, in a water-based system. Here, the capacitance is measured by a half cell test (using a 1 M sulfuric acid as an electrolyte) using a cyclic voltammetry apparatus (Solarstron 1480) after an electrode slurry is prepared using about 93% by weight (wt %) of the graphene-based composite and about 7 wt % of carboxymethyl cellulose (CMC)/styrene-butadiene rubber (SBR) as a water-based binder in terms of solid content excluding a solvent, and then coated onto a platinum electrode.

The present invention also relates to a method of preparing a graphene-based composite.

In one embodiment, the method of preparing a graphene-based composite may include: preparing a precursor solution by placing and dispersing graphene oxide and a pore agent in a solvent, followed by mixing the precursor solution with a metal oxide precursor; and preparing a graphene-based composite (porous graphene-metal oxide composite) by performing spraying and heat treatment of the precursor solution.

The graphene oxide may be reduced to form a graphene layer upon high-temperature drying, and may be prepared from graphene.

The graphene may be typical graphene prepared by various methods, for example, graphene prepared using graphite as a starting material. The graphite may be a natural material. Although any graphite may be used so long as the graphite is a natural material, in exemplary embodiments, expanded graphite (or exfoliated graphite) can be used. Methods for preparing the graphene may include without limitation an acid expansion method, an ultrasonic exfoliation method, a modified Hummers method, and the like.

One example of the acid expansion method will hereinafter be described in detail. In the acid expansion method, the acid used in acid treatment can be a commonly used acid such as sulfuric acid, nitric acid and the like, and a mixed solution of the acid may also be used.

The acid treatment can be performed at a temperature from about 50° C. to about 200° C., for example from about 50° C. to about 100° C., and as another example at a boiling point of the acidic solution used, or less. Although the amount of time for the acid treatment may vary with temperature, the acid treatment can be performed, for example, for about 1 hour to about 24 hours, as another example for about 1 hour to about 5 hours.

Next, the acid-treated graphite solution can be filtered to obtain acid-treated graphite. Here, before filtering, the acid-treated graphite solution may be washed with water or a dilute hydrochloric acid (HCl) solution to improve filtering efficiency. Here, if the dilute hydrochloric acid solution is used instead of water, there is a merit in that heat is not generated unlike washing using water.

Next, when the filtered acid-treated graphite is subjected to heat treatment without a separate drying process, ions trapped in the graphite can be emitted as a gas to thereby prepare graphene. The heat treatment may be performed at a temperature from about 200° C. to about 2,000° C. In exemplary embodiments, the heat treatment can be performed at a temperature from about 500° C. to about 1,200° C., for example from about 700° C. to about 1,200° C. for efficient gas emission. Gases used for heat treatment may include inert gases such as nitrogen, argon, helium and the like, and recover defects in the graphene, which may be generated due to high-temperature acid treatment, using hydrogen gas. In exemplary embodiments, a gas mixture of about 10 volume % of hydrogen and an inert gas can be used.

In addition, the modified Hummers method is a method of preparing graphene by preparing a graphene oxide using graphite, followed by reduction. Since the modified Hummers method is performed by way of an intermediate material, that is, the graphene oxide, the modified Hummers method allows easy combination of the graphene oxide with other materials, and allows a graphene composite to be synthesized through reduction of the composited graphene oxide.

In one embodiment, the graphene oxide may be prepared via a process of preparing a graphene oxide in the modified Hummers method. For example, after graphite is introduced into a mixed solution of sulfuric acid (H₂SO₄), potassium persulfate (K₂S₂O₈) and phosphorous pentoxide (P₂O₅), the graphite reacts with the mixed solution at about 80° C. for about 5 hours, followed by reacting the first oxidized graphite with a potassium permanganate (KMnO₄) solution, thereby preparing a graphene oxide.

In the preparation method, the graphene oxide can present in an amount of about 0.01 parts by weight to about 5 parts by weight, for example about 0.1 parts by weight to about 3 parts by weight, based on about 100 parts by weight of the solvent. Within this range, the graphene-based composite (porous graphene-metal oxide composite) having the aforementioned structure can be obtained.

The pore agent may form micelles on a surface of the graphene oxide and then degrade to form pores. The pore agent may be a typical pore agent. Examples of the pore agent may include without limitation anionic surfactants, such as sodium lauryl sulfate and the like, non-ionic surfactants, such as polyoxyethylene alkyl ether, polyethylene oxide-based tri-block copolymers and the like, and mixtures thereof. The pore agent may be present in an amount of about 1 part by weight to about 20 parts by weight, for example, about 1 part by weight to about 10 parts by weight, based on about 100 parts by weight of the solvent. Within this range, regular pores can be formed and channels can be provided for the graphene-based composite.

The metal oxide precursor may be bonded to the surface of the graphene oxide including the micelles formed by the pore agent, and then form a metal oxide. The metal oxide precursor may be any precursor, which can be dissolved to form a salt in a solvent, such as water, ethanol, methanol and the like, and become a metal oxide after reaction, without limitation. Examples of the metal oxide precursor may include without limitation tetraethoxy silane (TEOS), triacetoxymethyl silane, aluminum nitrate, aluminum chloride, aluminum isopropoxide, titanium isopropoxide, titanium chloride, titanium butoxide, titanium oxyacetylacetonate, zirconium acetylacetonate, zirconium acetate, zirconium butoxide, zirconium chloride, zinc acetate, zinc chloride, zinc nitrate hexahydrate, zinc chloride, yttrium nitrate hexahydrate, yttrium chloride, yttrium acetylacetonate, yttrium nitrate tetrahydrate, and the like, and mixtures thereof.

In the preparation method, the metal oxide precursor can be present in an amount of about 1 part by weight to about 20 parts by weight, for example about 1 part by weight to about 10 parts by weight, based on based on about 100 parts by weight of the solvent. Within this range, the metal oxide layer can form spherical pores having an appropriate wall thickness, and can form a graphene composite that exhibits inherent properties of graphene.

Examples of the solvent may include without limitation: water; alcohols such as methanol, ethanol, isopropanol, butanol, and the like; aromatic hydrocarbon solvents such as hexane, benzene, and the like, and mixtures thereof. In exemplary embodiments, the solvent may include water or alcohols.

In one embodiment, the precursor solution may be prepared through typical dispersion and mixing processes. In addition, spraying and heat treatment of the precursor solution may be performed by spraying droplets of the precursor solution into a reaction tube having a length from 1 m to about 10 m, followed by heat treatment at about 400° C. to about 1,000° C.

For example, the precursor solution may be sprayed in a droplet state by a method such as ultrasonic spraying, ultrasonic nozzles, general nozzles, and the like. To secure sufficient stay (residence) time for the graphene oxide, the pore agent and the metal oxide precursor to be combined into a porous graphene-metal oxide composite structure (a spherical particle-shaped structure in which the graphene layers and the metal oxide layers having pores and intercalated between the graphene layers are included, and the pores form channels) in the droplet, ultrasonic spraying may be used.

The precursor solution sprayed in a droplet state may be subjected to heat treatment in the reaction tube having a length from 1 m to about 10 m at about 400° C. to about 1,000° C., for example about 450° C. to about 800° C. to thereby form a spherical graphene-based composite (porous graphene-metal oxide composite). The length of the reaction tube and the temperature range are determined to provide a sufficient stay (residence) time allowing the sprayed droplets to form the composite structure. In addition, a reactor has a temperature, or a higher temperature, at which the metal oxide salt can sufficiently degrade to form an oxide. Since the reaction can be completed before the composite structure is formed at a significantly high temperature, an appropriate temperature can be selected within the temperature range.

The sprayed precursor solution droplets (precursor droplets) flow in the high-temperature reactor by, for example, a carrier gas, such as argon, nitrogen, helium gases and the like, and then reacts. Here, since the precursor droplets have an appropriate stay time due to influence by flow rate, length and temperature of the reactor, and the like, the precursor droplets are synthesized from a liquid-state droplet into a solid-state composite particle. In exemplary embodiments, the precursor solution (precursor droplet) can have a stay time from about 10 seconds to about 60 seconds. Within this range, the graphene-based composite can be prepared at high yield.

The graphene-based composite (porous graphene-metal oxide composite) may be prepared, for example, by typical spray pyrolysis using a typical spray pyrolysis apparatus including a solution spray device for formation of droplets and a high-temperature reaction tube in which the composite particles are formed, and the formed composite particles may be recovered by a particle recovery unit included in the spray pyrolysis apparatus, that is, a typical filter, and the like.

Spray pyrolysis is a vapor phase synthesis process allowing continuous synthesis of the graphene-based composite and allows easier mass production than wet processes by allowing synthesis of the graphene-based composite even within a short stay time of 1 minute. In addition, spray pyrolysis is environmentally friendly since additional processes of washing and heat treatment after synthesis are not required.

FIG. 6 is a diagram showing a method of preparing a graphene-based composite according to one embodiment of the present invention. As shown in FIG. 6, after a precursor solution 100 in a droplet state, which includes a graphene oxide 10, a pore agent 20, and a metal oxide precursor 30, is combined into a composite structure 200 in a high-temperature reactive tube, the graphene oxide 10 forms graphene layers, the pore agent 20 degrades to form pores 40, and the metal oxide precursor 30 forms a metal oxide layers, thereby forming a graphene-based composite 220 (porous graphene-metal oxide composite) (in the composite 220, remaining portions excluding the pores 40 are the graphene layers and the metal oxide layers of a stacked structure).

According to this embodiment, the method of preparing a graphene-based composite further includes: preparing a mold-precursor mixture solution by mixing a carbon precursor and a solvent with a mold when the graphene-based composite (porous graphene-metal oxide composite) is the mold; heating the mold-precursor mixture solution and carbonizing the carbon precursor filling pores of the mold; and removing a metal oxide from the mold through base or acid treatment thereof, thereby preparing a graphene-based composite (porous graphene-carbon composite).

The carbon precursor may be any one that can be carbonized to form a network along with neighboring carbon without limitation. Examples of the carbon precursor may include without limitation: carbohydrates such as sucrose, cellulose, and the like; C₄ to C₁₀ alcohols such as butanol, furfuryl alcohol, and the like; C₆ to C₃₀ aromatic compounds such as pyrene, naphthalene, benzene, trimethyl benzene, anthracene, and the like; and the like, and mixtures thereof.

In the preparation method, the carbon precursor can be present in an amount of about 100 parts by weight to about 300 parts by weight, for example about 130 parts by weight to about 200 parts by weight, based on about 100 parts by weight of the mold. Within this range, the carbon precursor can densely fill the pores in the mold.

In addition, the solvent may be water or the like, and may include an acid serving as a catalyst upon carbonization. The solvent can be present in an amount of about 400 parts by weight to about 1,000 parts by weight, for example about 500 parts by weight to about 700 parts by weight, based on based on about 100 parts by weight of the mold. Within this range, the carbon precursor can uniformly penetrate into the pores of the mold.

In one embodiment, the mixed solution of the mold and the carbon precursor may be heated at a temperature from about 100° C. to about 300° C., for example from about 100° C. to about 200° C., for a time from about 2 hours to about 20 hours, for example from about 3 hours to about 9 hours. Within this range, the carbon precursor can form a network well along with neighboring carbon.

In addition, carbonization can be performed at a temperature from about 300° C. to about 1,400° C., for example from about 700° C. to about 1,400° C., for a time from about 2 hours to about 10 hours, for example from about 3 hours to about 9 hours. Within this range, the carbon precursor can be carbonized to form carbon layers.

The metal oxide layers may be removed from the mold through base or acid treatment. The base treatment may be performed using an alkaline aqueous solution including sodium hydroxide, potassium hydroxide, calcium hydroxide, and the like, and mixtures thereof. In exemplary embodiments, the base treatment can be performed using an alkaline aqueous solution including sodium hydroxide. The acid treatment may be performed using an acidic aqueous solution including hydrogen fluoride, hydrogen chloride, hydrogen iodide, hydrogen bromide, acetic acid, and the like, and mixtures thereof.

Since the metal oxide of the mold is removed using the alkaline or acidic aqueous solution, the carbon layer includes carbon particles formed in the pores of the metal oxide layer of the mold and the pores, which are formed by removing the metal oxide from the metal oxide layer in the mold. The pores may have an irregular shape or a channel shape.

Conditions for acid or base treatment may vary depending on the kinds of metal oxide in the mold, and are not strictly limited so long as the metal oxide can be sufficiently removed under the conditions. For example, the alkaline or acidic aqueous solution may have a concentration from about 0.1 M to about 2.0 M, and the base or acid treatment can have a treatment time from about 30 minutes to about 2 hours, and a treatment temperature from about 50° C. to about 150° C., without being limited thereto.

In another embodiment, a method of preparing a graphene-based composite may include: preparing a graphene-carbon-metal oxide composite by mixing graphene, a carbon precursor, a metal oxide precursor, a pore agent and a solvent, followed by heat treatment; and removing a metal oxide from the graphene-carbon-metal oxide composite.

In the preparation method, the graphene may be typical graphene prepared by various methods, or a graphene oxide which can be reduced to form graphene upon heat treatment. For example, the graphene may be graphene or graphene oxide prepared using graphite as a starting material. The graphite may be a natural material. Although any graphite may be used so long as the graphite is a natural material, for example, expanded graphite (or exfoliated graphite) may be used. Methods for preparing the graphene may include without limitation an acid expansion method, an ultrasonic exfoliation method, a modified Hummers method, and the like.

In one embodiment, the graphene may be graphene oxide, which is an intermediate material according to the modified Hummers method, or graphene (reduced graphene oxide), without being limited thereto.

In the preparation method, the graphene can be present in an amount of about 0.01 parts by weight to about 5 parts by weight, for example about 0.05 parts by weight to about 3 parts by weight, based on about 100 parts by weight of the solvent. Within this range, the porous graphene-carbon composite having a non-repetitive and irregular three-dimensional structure can be obtained.

In one embodiment, the carbon precursor may be dissolved in a solvent such as water and the like and be carbon-polymerized (condensed between carbon) at a certain temperature, or higher, in the presence of acid catalyst.

In addition, due to carbonization upon heat treatment, the carbon precursor connects three-dimensional graphene structures formed by crumpling planar graphene, and forms a carbon compound capable of maintaining the three-dimensional structure of the graphene by coating the carbon precursor onto a partial or overall surface of the three-dimensional graphene structures.

Examples of the carbon precursor may include without limitation: carbohydrates such as sucrose, cellulose, and the like; C₄ to C₁₀ alcohols such as butanol, furfuryl alcohol, and the like; C₆ to C₃₀ aromatic compounds such as pyrene, naphthalene, benzene, trimethyl benzene, anthracene, and the like; and mixtures thereof. For example, the carbon precursor may include C₄ to C₆ alcohol.

The carbon precursor can be present in an amount of about 2 parts by weight to about 20 parts by weight, for example about 3 parts by weight to about 10 parts by weight, based on about 100 parts by weight of the solvent. Within this range, the carbon precursor can maintain and connect three-dimensional graphene structures, and can form sufficient pores.

In one embodiment, the metal oxide precursor serves to form planar graphene into a three-dimensional structure when dispersed in the solvent along with the graphene, and forms a metal oxide through a first heat treatment. The metal oxide precursor may be any precursor, which can be dissolved to form a salt in a solvent, such as water, alcohol and the like, and becomes the metal oxide after reaction, without limitation. Examples of the metal oxide precursor may include without limitation tetraethoxy silane (TEOS), triacetoxymethyl silane, aluminum nitrate, aluminum chloride, aluminum isopropoxide, titanium isopropoxide, titanium chloride, titanium butoxide, titanium oxyacetylacetonate, zirconium acetylacetonate, zirconium acetate, zirconium butoxide, zirconium chloride, zinc acetate, zinc chloride, zinc nitrate hexahydrate, zinc chloride, yttrium nitrate hexahydrate, yttrium chloride, yttrium acetylacetonate, yttrium nitrate tetrahydrate, and the like, mixtures thereof, without being limited thereto. For example, the metal oxide precursor may be tetraethoxy silane.

The metal oxide precursor can be present in an amount of about 2 parts by weight to about 10 parts by weight, for example about 4 parts by weight to about 8 parts by weight, based on about 100 parts by weight of the solvent. Within this range, the metal oxide precursor can form three-dimensional graphene.

In one embodiment, the pore agent may form micelles, which are surrounded by the graphene and the carbon precursors or by the carbon precursors in the solvent, and degrade to form the pores including a portion of the graphene inside the carbon compound in the graphene-carbon composite during heat treatment. The pore agent may be a typical pore agent (surfactant). Examples of the pore agent may include without limitation anionic surfactants, such as sodium lauryl sulfate and the like, non-ionic surfactants, such as polyoxyethylene alkyl ether, polyethylene oxide-based tri-block copolymers and the like, and mixtures thereof. In exemplary embodiments, the pore agent may be a polyethylene oxide-based tri-block copolymer.

The pore agent may be present in an amount of about 2 parts by weight to about 15 parts by weight, for example about 3 parts by weight to about 10 parts by weight, based on about 100 parts by weight of the solvent. Within this range, sufficient pores can be formed, thereby providing a porous graphene-carbon composite that can have excellent capacitance.

Examples of the solvent may include without limitation: water; alcohols such as methanol, ethanol, isopropanol, butanol, and the like; aromatic hydrocarbon solvents such as hexane, benzene, and the like, and mixtures thereof. In exemplary embodiments, the solvent may include at least one of water or alcohols.

In the preparation method of the graphene-based composite (porous graphene-carbon composite) according to another embodiment, mixing may be performed through a typical mixing method such as stirring and the like, and heat treatment may be performed by gradually increasing the temperature from about 300° C. to about 1,000° C. For example, heat treatment may be separated into a first, second and third heat treatment, which may be separately performed.

In one embodiment, the mixing and first heat treatment can be performed at about 30° C. to about 50° C., for example about 30° C. to about 40° C., for about 1 hour to about 40 hours, for example about 10 hours to about 30 hours. Within this range, the graphene can form a three-dimensional structure, sufficient micelles can be formed by the carbon precursor, the pore agent and the like, and the metal oxide precursor can become a metal oxide.

In addition, a second heat treatment can be performed, for example, at about 100° C. to about 200° C., for example about 110° C. to about 180° C., for about 1 hour to about 20 hours, for example about 3 hours to about 15 hours. Within this range, the carbon precursors can be carbon-polymerized.

Upon the second heat treatment, the mixture may further include an acid catalyst capable of starting and promoting carbon polymerization. The acid catalyst may be a typical acid catalyst such as but not limited to nitric acid, hydrochloric acid, sulfuric acid, and the like. The acid catalyst may be present in an amount of about 0.1 parts by weight to about 10 parts by weight based on about 100 parts by weight of the solvent, without being limited thereto.

Further, when a graphene oxide is used as graphene, a third heat treatment can be a process for preparing a graphene-based composite (porous graphene-carbon composite) by reducing the graphene oxide to form graphene, followed by final carbonization of the carbon precursor. The third heat treatment may be performed using a furnace capable of maintaining an inert or reducing atmosphere therein. Examples of an inert gas may include without limitation nitrogen, argon, hydrogen, and the like. These may be used alone or in combination thereof. The third heat treatment can be performed at about 400° C. to about 1,500° C., for example about 700° C. to about 1,000° C. Within this range, the graphene-carbon-metal oxide composite with a non-repetitive and irregular three-dimensional structure can be obtained. The third heat treatment may be performed for about 1 hour to about 10 hours, without being limited thereto.

In the preparation method, removal of the metal oxide from the graphene-carbon-metal oxide composite may be performed using an acid or a base. For example, removal can be performed using an acidic aqueous solution including fluoric acid, nitric acid, sulfuric acid, and/or hydrochloric acid, or an alkaline aqueous solution including sodium hydroxide and/or potassium hydroxide, for example a fluoric acid or aqueous potassium hydroxide solution. Conditions for using (treating with) the acid or base may vary with the formed metal oxide, and are not strictly limited so long as the metal oxide can be removed from the graphene-carbon-metal oxide composite under the conditions. For example, treatment with the acid or base may be performed at about 30° C. to about 80° C. for about 1 hour to about 5 hours, without being limited thereto.

In addition, the preparation method may further include a post-process step such as a typical drying process and the like, which can be performed after treatment with the acid or base, thereby obtaining the graphene-based composite (porous graphene-carbon composite).

According to the one embodiment, the graphene-based composite (porous graphene-metal oxide composite) can exhibit inherent properties of graphene due to the above structure, and simultaneously can secure an ion transfer path and an electrical conduction path. In addition, the graphene-based composite (porous graphene-carbon composite) can exhibit inherent properties of graphene due to the above structure, and can have a large specific surface area, excellent charge storage capacity, and high energy density.

According to another embodiment of the invention, the graphene-based composite (porous graphene-carbon composite) can prevent graphene from being stacked and can have high capacitance due to a non-repetitive and irregular three-dimensional structure and a porous structure.

Thus, the graphene-based composite according to the invention may be applied to electrode active materials for secondary batteries and super capacitors, catalyst carriers, and the like.

Hereinafter, the present invention will be described in more detail with reference to the following examples. However, it should be noted that these examples are provided for illustration only and are not to be construed in any way as limiting the present invention.

### EXAMPLE

### Example 1

Graphite is introduced into a mixed solution of sulfuric acid (H₂SO₄), potassium persulfate (K₂S₂O₈) and phosphorous pentoxide (P₂O₅), and the graphite reacts with the mixed solution at 80° C. for about 5 hours to form a first oxidized graphite. The first oxidized graphite is reacted with a potassium permanganate (KMnO₄) solution at 35° C. for 2 hours to prepare a graphene oxide. 0.1 g of the prepared graphene oxide is dispersed in a solution, in which 2 g of a polyethylene oxide-based tri-block copolymer as a pore agent is dissolved in 100 g of water, followed by dissolving 5 g of tetraethoxy silane (TEOS) as a metal oxide precursor, thereby preparing a precursor solution. Droplets of the prepared precursor solution are sprayed into a spray pyrolysis apparatus in an argon atmosphere using an ultrasonic sprayer. The sprayed precursor solution droplets are prepared into graphene-based composite (porous graphene-metal oxide composite, graphene-SiO₂) particles having the structure according to the invention in a high-temperature reaction tube having a length of 1 m and a temperature of 500° C., and the prepared particles are collected by a filter. Scanning electron microscope (SEM) and transmission electron microscope (TEM) images of the prepared graphene-based composite are shown in FIGS. 1 and 2, respectively.

### Example 2

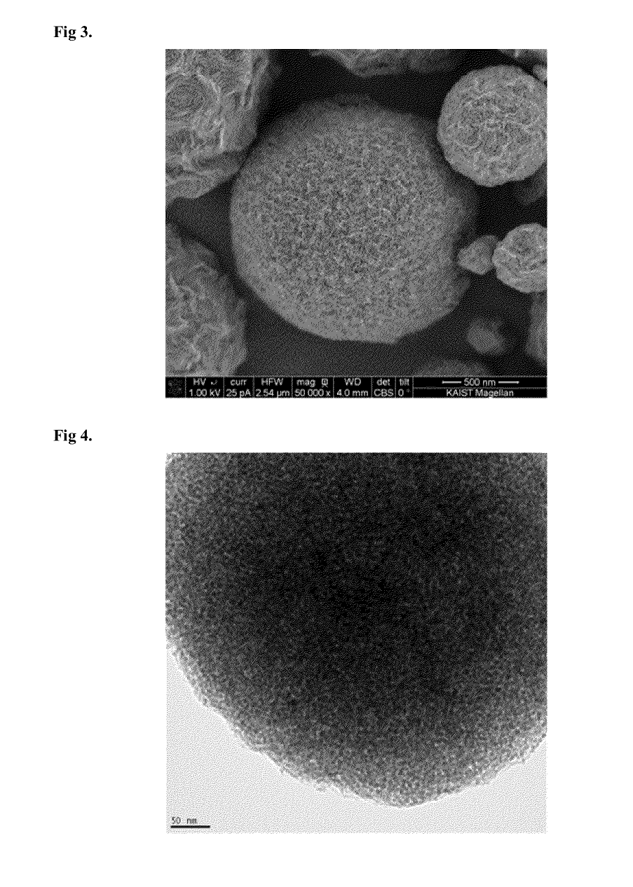

Graphene-based composite (porous graphene-metal oxide composite, graphene-SiO₂) particles are prepared in the same manner as in Example 1 except that 5 g of the pore agent is used instead of 2 g. Scanning electron microscope (SEM) and transmission electron microscope (TEM) images of the prepared graphene-based composite are shown in FIGS. 3 and 4, respectively.

### Comparative Example 1

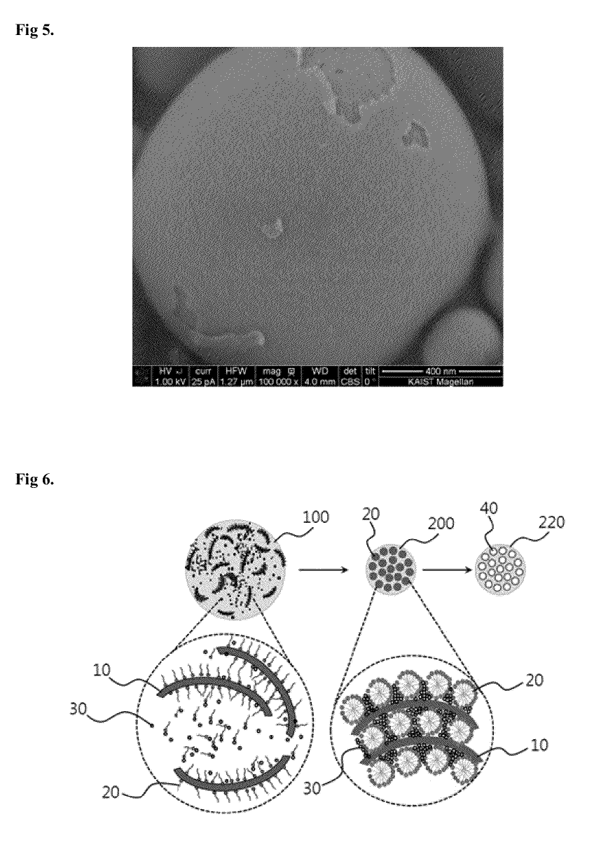

Porous metal oxide (SiO₂) particles are prepared in the same manner as in Example 1 except that the graphene oxide is not used. A scanning electron microscope (SEM) image of the prepared porous metal oxide is taken, and the image is shown in FIG. 5.

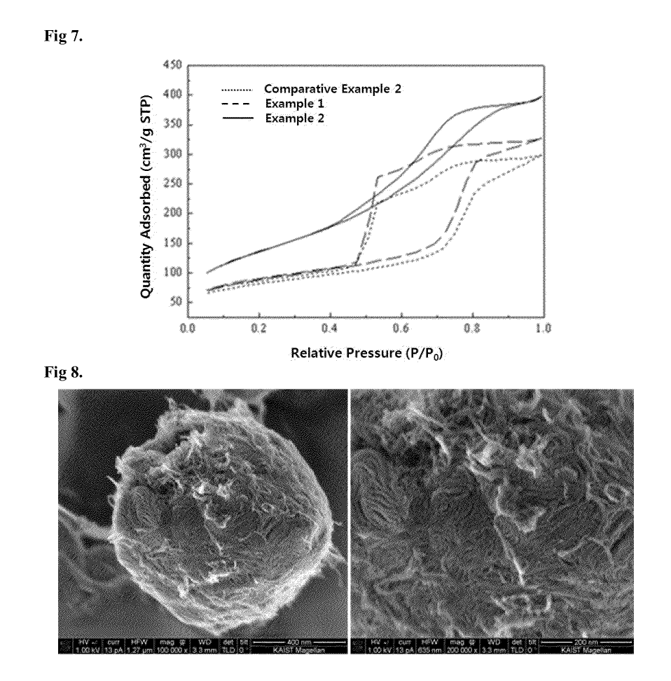

From the results of FIGS. 1 to 4, it can be confirmed that the graphene-based composite (porous graphene-metal oxide composite, graphene-SiO₂) is a (spherical) particle including graphene layers and metal oxide layers intercalated between the graphene layers, that the graphene layers and the metal oxide layers of the particle may have regularity (FIGS. 1 and 2) or may not have regularity (FIGS. 3 and 4) overall, and that pores formed in the metal oxide layers form channels in the particle, thereby securing both an ion transfer path and an electrical conduction path. In addition, FIG. 7 shows graphs of adsorption and desorption of nitrogen of the graphene-based composite particles and the metal oxide particles prepared in Examples 1 and 2 and Comparative Example 1, as measured using a BET measuring apparatus. It can be seen that the porous graphene-based composite is a material having the pores.

### Example 3

0.1 g of graphene oxide synthesized by a typical modified Hummers method is dispersed in a solution, in which 2 g of a polyethylene oxide-based tri-block copolymer as a pore agent is dissolved in 100 g of water, followed by dissolving 5 g of tetraethoxy silane (TEOS) as a metal oxide precursor, thereby preparing a precursor solution. Droplets of the prepared precursor solution are sprayed into a spray pyrolysis apparatus in an argon atmosphere using an ultrasonic sprayer. The sprayed precursor solution droplets are prepared into porous graphene-metal oxide composite (graphene-SiO₂) particles in a high-temperature reaction tube having a length of 1 m and a temperature of 500° C., and the prepared particles are collected by a filter. Next, after 1 g of the graphene-SiO₂, 1.25 g of sucrose, 5 g of distilled water and 0.14 g of sulfuric acid are mixed, the components are reacted by heating at 100° C. for 6 hours, followed by heating at 350° C. for 2 hours and at 750° C. for 2 hours, thereby performing carbonization. After carbonization, a metal oxide (SiO₂) is removed from the graphene-SiO₂ using a 1.0 M sodium hydroxide aqueous solution, thereby preparing a graphene-based composite (porous graphene-carbon composite). Scanning electron microscope (SEM) and enlarged images, and a transmission electron microscope (TEM) image of the prepared graphene-based composite are shown in FIGS. 8 and 9, respectively.

### Example 4

A graphene-based composite (porous graphene-carbon composite) is prepared in the same manner as in Example 3 except that 5 g of the pore agent is used instead of 2 g. Scanning electron microscope (SEM) and enlarged images, and a transmission electron microscope (TEM) image of the prepared graphene-based composite are shown in FIGS. 10 and 11, respectively.

### Comparative Example 2

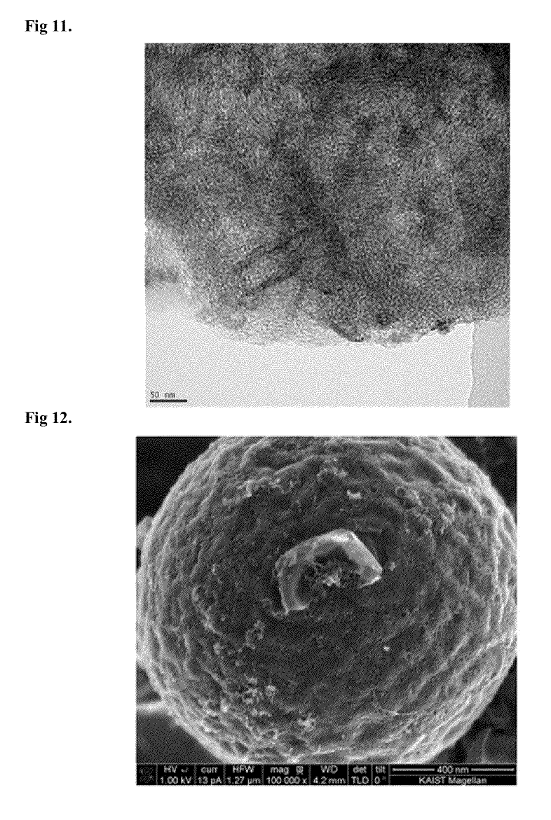

A porous carbon structure is prepared in the same manner as in Example 3 except that the graphene oxide is not used. A scanning electron microscope (SEM) image of the prepared porous carbon structure is taken, and the image is shown in FIG. 12.

Property Evaluation

(1) Capacitance: An electrode slurry is prepared using 80 wt % of each of the graphene-based composites of Examples 3 and 4 and the porous carbon structure of Comparative Example 2, 10 wt % of polyvinylidene fluoride (PVDF) as a binder, 10 wt % of carbon black and N-methyl-2-pyrrolidone (NMP) as a solvent, followed by coating the electrode slurry onto a platinum electrode, thereby preparing an electrode material. A half cell test (using a 1.0 M sulfuric acid electrolyte) is performed using a cyclic voltammetry apparatus (Solarstron 1480), thereby measuring capacitance. Results are shown in Table 1.

(2) Specific surface area and Pore volume: After quantification of an amount of adsorption-desorption of nitrogen is performed using a NOVA 4200, a specific surface area and pore volume of each of the graphene-based composites of Examples 3 and 4 and the porous carbon structure of Comparative Example 2 are measured using Brunauer-Emmett-Teller (BET) and Barrett-Joyner-Helenda (BJH) methods. Before measurement, degassing is performed at 200° C. for 2 hours, thereby removing impurities from a measurement specimen.

TABLE 1

| | | | Comparative |
|---|---|---|---|
| | Example 3 | Example 4 | Example 2 |
| Capacitance (F/g) | 198 | 201 | 130 |
| Specific surface area (m²/g) | 879 | 1,057 | 627 |
| Pore volume (cm³/g) | 0.58 | 0.90 | 1.17 |

From the results of FIGS. 8 to 11, it can be seen that the graphene-based composite (porous graphene-carbon composite) according to the invention is a spherical particle formed by alternately stacking the graphene layers and the carbon layers, that the graphene layers and the carbon layers of the spherical particle may have regularity (FIGS. 8 and 9) or may not have regularity (FIGS. 10 and 11), and that pores formed in the carbon layers form channels in the spherical particle and thus allow the graphene-based composite to have a large specific surface area, excellent charge storage capacity, and high energy density. This can be confirmed from the results of specific surface area, pore volume and capacitance shown in Table 1.

### Example 5

Graphite is introduced into a mixed solution of sulfuric acid (H₂SO₄), potassium persulfate (K₂S₂O₈) and phosphorous pentoxide (P₂O₅), and the graphite reacts with the mixed solution at 80° C. for about 5 hours to form a first oxidized graphite. The first oxidized graphite is reacted with a potassium permanganate (KMnO₄) solution at 35° C. for 2 hours to prepare a graphene oxide. 0.1 g of the graphene oxide prepared using a modified Hummers method, 8 g of butanol as a carbon precursor, 8 g of tetraethoxy silane (TEOS) as a metal oxide precursor, 4 g of a polyethylene oxide-based tri-block copolymer as a pore agent, and 3 g of nitric acid as an acid catalyst are introduced into 100 g of water, and then are mixed and reacted (first heat treatment) at 38° C. for 24 hours, followed by aging at 100° C. for 24 hours. Next, a second heat treatment is performed at 160° C. for 6 hours, thereby performing a process of connecting backbones. After a second heat treatment, a third heat treatment is performed at 700° C. for 2 hours in a nitrogen atmosphere using a high-temperature furnace, thereby synthesizing a graphene-carbon-metal oxide (silica) composite. The silica is removed from the prepared graphene-carbon-metal oxide composite using a 0.2 M NaOH aqueous solution, followed by drying, thereby preparing a three-dimensional graphene-based composite (porous graphene-carbon composite). A scanning electron microscope (SEM) image of the prepared graphene-based composite is taken, and the image is shown in FIG. 13. In addition, pore size distribution of the prepared graphene-based composite is measured using an amount of desorption of nitrogen, and results are shown in FIG. 14. Capacitance is measured according to the following evaluation method, and results are shown in FIG. 16.

### Comparative Example 3

Flake-shaped graphene is prepared using an ultrasonic exfoliation method. An

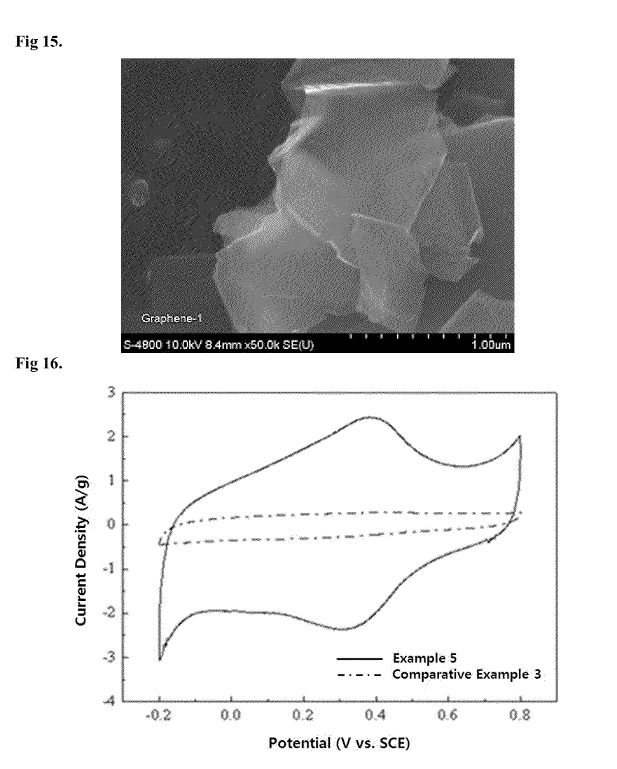

SEM image and capacitance of the prepared graphene are obtained in the same manner as in Example 5, and results are shown in FIGS. 15 and 16.

Property Evaluation

(1) Capacitance (unit: F/g): Each electrode slurry is prepared using 93 wt % of the graphene-based composite (porous graphene-carbon composite) of Example 5 excluding the solvent or the graphene of Comparative Example 3, and 7 wt % of carboxy methyl cellulose (CMC)/styrene-butadiene rubber (SBR) as a water-based binder, followed by coating the electrode slurry onto a platinum electrode, thereby measuring capacitance by a half cell test (using a 1 M sulfuric acid electrolyte) using a cyclic voltammetry apparatus (Solarstron 1480).

(2) Specific surface area (unit: m²/g) and Pore volume (unit: cm²/g): After quantification of an amount of adsorption-desorption of nitrogen is performed using a NOVA 4200, a specific surface area and pore volume of each of the graphene-based composite of Example 5 and the graphene of Comparative Example 3 are measured using Brunauer-Emmett-Teller (BET) and Barrett-Joyner-Helenda (BJH) methods. Before measurement, degassing is performed at 200° C. for 2 hours, thereby removing impurities physically adsorbed onto a measurement specimen.

TABLE 2

| | Example 5 | Comparative Example 3 |
|---|---|---|
| Capacitance (F/g) | 302 | 50 |
| Specific surface area (m²/g) | 483 | 100 |
| Pore volume (cm³/g) | 0.7 | — |

From the results of Table 2 and FIGS. 13 to 16, it can be seen that the graphene-based composite (porous graphene-carbon composite, Example 5) is a particle of a non-repetitive and irregular three-dimensional structure, and has superior capacitance, specific surface area and pore volume to the typical planar (flake-shaped) graphene (Comparative Example 3).

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A graphene-based composite comprising:
graphene; and
a structure former contacting the graphene,
wherein the structure former is a metal oxide or a carbon compound and comprises pores therein, and the graphene-based composite has a porous particle structure.

2. The graphene-based composite according to claim 1, wherein the pores have a spherical, irregular, or channel shape.

3. The graphene-based composite according to claim 1, wherein the pores have a diameter from about 1 μm to about 50 μm.

4. The graphene-based composite according to claim 1, wherein the graphene comprises a plurality of graphene layers separated a predetermined distance from each other; the structure former is intercalated between the graphene layers; and the pores form channels.

5. The graphene-based composite according to claim 4, wherein the graphene-based composite has a structure in which the graphene layer and the structure former are alternately stacked.

6. The graphene-based composite according to claim 4, wherein the graphene layers have a thickness from about 1 nm to about 10 nm, and an interlayer distance from about 1 nm to about 100 nm.

7. The graphene-based composite according to claim 4, wherein the graphene-based composite is a spherical particle having an average diameter from about 100 nm to about 10,000 nm, a specific surface area from about 300 m²/g to about 1,500 m²/g, and a capacitance from about 150 F/g to about 400 F/g.

8. The graphene-based composite according to claim 1, wherein the metal oxide comprises silicon oxide (SiO₂), aluminum oxide (Al₂O₃), zirconium oxide (ZrO₂), yttrium oxide (Y₂O₃), titanium oxide (TiO₂), zinc oxide (ZnO), or a mixture thereof.

9. The graphene-based composite according to claim 1, wherein the carbon compound comprises a carbohydrate, C₄ to C₁₀ alcohol, C₆ to C₃₀ aromatic compound, or a mixture thereof.

10. The graphene-based composite according to claim 1, wherein the graphene-based composite has a non-repetitive and irregular three-dimensional structure.

11. The graphene-based composite according to claim 10, wherein the pores of the graphene-based composite comprise first pores having a diameter from about 1 nm to about 5 nm, and second pores having a diameter of greater than about 5 nm and about 50 nm or less.

12. The graphene-based composite according to claim 10, wherein the graphene-based composite has a structure in which the carbon compound connects at least two three-dimensional graphene structures, or is coated onto a partial or overall surface of the three-dimensional graphene structure.

13. A method of preparing a graphene-based composite comprising:
preparing a precursor solution by placing and dispersing graphene oxide and a pore agent in a solvent, followed by mixing the precursor solution with a metal oxide precursor; and
performing spraying and heat treatment of the precursor solution to form a graphene-based composite.

14. The method according to claim 13, wherein the graphene oxide is present in an amount of about 0.01 parts by weight to about 5 parts by weight, the pore agent is present in an amount of about 1 part by weight to about 20 parts by weight, and the metal oxide precursor is present in an amount of about 1 part by weight to about 20 parts by weight, based on about 100 parts by weight of the solvent.

15. The method according to claim 13, wherein the pore agent comprises an anionic surfactant, an non-ionic surfactant, or a mixture thereof.

16. The method according to claim 13, wherein the metal oxide precursor comprises tetraethoxy silane (TEOS), triacetoxymethyl silane, aluminum nitrate, aluminum chloride, aluminum isopropoxide, titanium isopropoxide, titanium chloride, titanium butoxide, titanium oxyacetylacetonate, zirconium acetylacetonate, zirconium acetate, zirconium butoxide, zirconium chloride, zinc acetate, zinc chloride, zinc nitrate hexahydrate, zinc chloride, yttrium nitrate hexahydrate, yttrium chloride, yttrium acetylacetonate, yttrium nitrate tetrahydrate, or a mixture thereof.

17. The method according to claim 13, further comprising:
preparing a mold-precursor mixture solution by mixing a carbon precursor and a solvent with a mold using the graphene-based composite as the mold;
heating the mold-precursor mixture solution and carbonizing the carbon precursor filling pores of the mold; and
removing a metal oxide from the mold through base or acid treatment thereof.

18. The method according to claim 17, wherein the carbon precursor comprises a carbohydrate, C₄ to C₁₀ alcohol, C₆ to C₃₀ aromatic compound, or a mixture thereof.

19. A method of preparing a graphene-based composite comprising:
preparing a graphene-carbon-metal oxide composite by mixing graphene, a carbon precursor, a metal oxide precursor, a pore agent and a solvent, followed by heat treatment; and
removing a metal oxide from the graphene-carbon-metal oxide composite.

20. The method according to claim 19, wherein the heat treatment is performed by gradationally increasing temperature starting from about 300° C. to about 1,000° C.

21. The method according to claim 19, wherein the graphene is present in an amount of about 0.01 parts by weight to about 5 parts by weight, the carbon precursor is present in an amount of about 2 parts by weight to about 20 parts by weight, the metal oxide precursor is present in an amount of about 2 parts by weight to about 10 parts by weight, and the pore agent is present in an amount of about 2 parts by weight to about 15 parts by weight, based on about 100 parts by weight of the solvent.

22. The method according to claim 19, wherein removal of the metal oxide is performed using an acid or a base.

23. A catalyst carrier comprising a graphene-based composite, wherein the graphene-based composite comprises graphene; and a structure former contacting the graphene, wherein the structure former is a metal oxide or a carbon compound and comprises pores therein, and the graphene-based composite has a porous particle structure.

24. The catalyst carrier according to claim 23, wherein the graphene comprises a plurality of graphene layers separated a predetermined distance from each other; the structure former is intercalated between the graphene layers; and the pores form channels.

25. The catalyst carrier according to claim 23, wherein the graphene-based composite has a non-repetitive and irregular three-dimensional structure.

26. An electrode active material comprising a graphene-based composite, wherein the graphene-based composite comprises graphene; and a structure former contacting the graphene, wherein the structure former is a metal oxide or a carbon compound and comprises pores therein, and the graphene-based composite has a porous particle structure.

27. The electrode active material according to claim 26, wherein the graphene comprises a plurality of graphene layers separated a predetermined distance from each other; the structure former is intercalated between the graphene layers; and the pores form channels.

28. The electrode active material according to claim 26, wherein the graphene-based composite has a non-repetitive and irregular three-dimensional structure.
